(19) United States
(12) Patent Application Publication
(10) Pub. No.: US 2017/0155548 A1
(43) Pub. Date: Jun. 1, 2017

(54) ARRANGEMENTS AND METHODS PERFORMED BY A WIRELESS COMMUNICATION NETWORK AND A ROUTER FOR FACILITATING ROUTING OF DATA PACKETS IN THE NETWORK

(71) Applicant: TELEFONAKTIEBOLAGET LM ERICSSON (PUBL), Stockholm (SE)

(72) Inventors: Alexander Lindström, SOLNA (SE); Fredrik Sonnevi, Hägersten (SE); Linda Brus, VÄLLINGBY (SE)

(21) Appl. No.: 14/650,061

(22) PCT Filed: Jun. 2, 2015
(86) PCT No.: PCT/SE2015/050640

§ 371 Date: Jun. 5, 2015

(51) Int. Cl. H04L 12/24; H04L 12/721; H04W 28/02

(52) U.S. Cl. CPC H04L 41/08; H04W 28/0263; H04L 45/38

(57) ABSTRACT

A method is described performed by a wireless communication network for facilitating routing of data packets in the network. The wireless communication network comprises a network node, a number of base stations and a number of routers connecting the network node to the base stations. The method comprises obtaining transport bearer associations in which a plurality of transport bearer ID ranges are individually associated with one or more transport bearer parameter values of a plurality of transport bearer parameter values, and triggering provision of the obtained transport bearer associations to one or more of the number of routers.

### TECHNICAL FIELD

The present disclosure relates generally to arrangements and methods performed by a wireless communication network for facilitating routing of data packets in the network, and to routers of the network and methods performed by the router for routing data packets in the network.

### BACKGROUND

A wireless communication network is constructed from a set of radio applications running on top of, typically, an IP network infrastructure comprising a plurality of routers. On an application level, network nodes, e.g. base stations and RNCs are communicating directly with each other, but on an IP packet level, the RNCs and base stations are exchanging data packets between each other via the IP network, i.e. via the plurality of routers. IP packets are tunneled between the network nodes in transport bearers, which are assigned a priority code point, DSCP, that is enforced in the IP network infrastructure. Each router in the IP network infrastructure typically routes each packet individually based on the IP destination address and the DSCP, but policy-based routing based on headers inside the network packet payload is usually also supported.

The network nodes provide a number of User Equipment, UE, belonging to mobile subscribers, with an IP connectivity service to a PDN (typically, the Internet). Each of the UE's IP connectivity services is aggregated into the same IP packet flow. UEs may use a range of different user applications and different TCP implementations inside this IP flow.

The IP network infrastructure is usually divided into different logical domains and referred to as transport/backhaul, aggregation, or core networks. The IP network infrastructure has a certain amount of capacity available for use by the radio applications in any of these logical domains. This capacity is not limitless.

Regulation of data flows between hosts connected to the Internet, and attached access/wireless networks, is predominately handled by the end-point TCP stacks. Data transport protocols like TCP always strive to get as much throughput through the serving network as possible. This constantly causes temporary spikes of congestion, or rate oscillations, as UEs communicate across the serving network. Depending on the UE applications' behaviors, i.e. their use of TCP, number of TCP flows used, etc., some of the UE applications will get more throughput than others, unless the network polices/shapes the TCP flows individually. Several flow control mechanisms, which are described in the following, are employed in the wireless network to assure desired regulation of flows:
Active Queue Management, AQM: Actively manages the packet queues on an output interface to keep queue delay down, i.e. eliminate buffer bloat, and prioritize flows proportionally to the flow sizes. Combined with TCP, the end-to-end flows are approximately given equal shares of the network capacity. AQM is based on queue occupancy.
UTRAN, High Speed Packet Access, HSPA, flow control: Regulates flows between RNC and RBS. The algorithm used is similar to TCP's, but also considers for example cell load. Based on receiver congestion feedback.
ConEx/ConEx Lite: Regulates flows between two network points. Example points in the mobile network are, in 3G, Node B and RNC, and, in Long Term Evolution, LTE, also called 4G, evolved Node B and S-GW. ConEx is similar to TCP and UTRAN flow control, but with a different control algorithm. Applicable to multi-standard scenarios. In effect, dynamic flow policing. Based on receiver congestion feedback.
Policing/shaping: Static rate enforcement on specific input ports or output queues. Based on policer/shaping state, typically illustrated by token buckets.
Scheduling: Prioritized selection of packets from queues. Based on queue occupancy.

Another aspect of the IP network infrastructure is load balancing. Equal-cost multipath, ECMP, can be used to balance load onto the available equal-cost shortest paths in the IP network infrastructure. Paths are typically selected by computing a path index, or output port number) using a hash function. This path index is then used to select one out of (potentially) several possible output ports. In this way network load is distributed across multiple paths in the IP network infrastructure.

In terms of load-balancing, the current problem with existing solutions is they do not balance load by flow magnitudes. More precisely, because flows are mapped to output ports based only on the flow identifier, the IP network infrastructure ends up in a state with possible uneven loads on different paths.

In terms of flow fairness, the following problems exist: Flow control mechanisms like TCP, UTRAN flow control, and ConEx Lite all rely on receiver feedback about packet loss to regulate the flows. In general it is very difficult to provide exactly fair treatment between all pairs of active senders and receivers. This is because the packet Round-Trip Time, RTT, i.e. feedback latency, varies between pairs of senders and receivers. Another reason is the mix of flow control algorithms used in different parts of the network. With a flow control solution, flow rates are constantly oscillating as an effect of the probing nature of these algorithms. Fairness control is further hampered if the IP network infrastructure treats flows differently, i.e. in the router scheduling processes. Also, smaller flows that fit within the initial transmission window will not be rate controlled.

AQM can be configured differently depending on e.g. subscription, for example, subscriber may have gold, silver or bronze subscription, and the flows in the network may be prioritized differently depending on these, but AQM will only reduce flow rates proportionally to their flow size. That means that it is not possible to assign a flow a particular share of the available network capacity independent of the flow sizes. If flow control is used in combination, then the reliance on that flow control gives the same issues as has been mentioned for the flow control mechanisms.

What has the best fairness resolution of today's technology is the router scheduling process. This is because when scheduling, congestion is reacted to immediately as it is detected, independent of user application behavior. Congestion is detected when the scheduled queue(s) start to fill up. Hence, the feedback loop to the reacting process, i.e. the scheduler, is very short. Furthermore, all flows passing through the congestion point, potentially received from multiple different senders, get exposed to the same identical regulation, i.e. scheduling, process. In effect, all flows get a consistent fairness treatment as determined by the scheduling algorithm. Weighted fair queuing, WFQ, is an algorithm that can be used to differentiate between for example gold, silver, and bronze flows proportionally fair to their weights.

While statistics help to keep the number of simultaneously active flows down, in a multi-standard mobile network, the amount of potentially active flows may be higher in the router than in the network nodes. Depending on network location, a router may worst-case be exposed to ten to hundred thousands of flows simultaneously. Existing mechanisms either statically assign flows to specific queues or uses a hash function to distribute flows onto queues. By using hash functions to allocate queues, some flows may collide even though there are free queues available for use. Consequently hash-based queue selection may not be optimal.

Unorganized data is costly to manage. In case the radio application flows' identifiers are unorganized, more configuration, memory, and processing needs to be reserved to flow in the router.

Separate configuration of router forwarding & scheduling and radio bearers introduce an element of risk of mismatching configurations. Mismatching configuration leads to higher operational expenses related to fault resolution and unhappy customers if service is taken out of order. Separately managed configurations also introduce a lead time associated with changing the router configurations to match changed radio application configurations. This limits the mobile network operator's time to market for launching new services.

As shown, there is a need for improving routing of data packets in a wireless communication network. Especially, there is a need for improving the routing process at routers of the wireless communication network.

### SUMMARY

It is an object of the invention to address at least some of the problems and issues outlined above. A possible object is to improve routing of data packets in a wireless communication network. It is possible to achieve at least some of these objects by using methods, arrangements and routers as defined in the attached independent claims.

According to one aspect, a method is described performed by a wireless communication network for facilitating routing of data packets in the network. The wireless communication network comprises a first network node, a second network node and a number of routers connecting the first network node to the second network node. The method comprises obtaining a transport bearer associations in which a plurality of transport bearer ID ranges are individually associated with one or more transport bearer parameter values of a plurality of transport bearer parameter values, and triggering provision of the obtained transport bearer associations to one or more of the number of routers.

According to another aspect, a method is provided, performed by a first router of a wireless communication network for routing data packets in the network. The wireless communication network further comprises a number of first network nodes, a number of second network nodes and a number of additional routers, the first router and the number of additional routers connecting the number of first network nodes to the number of second network nodes. The method comprises receiving, from the first network node, transport bearer associations in which a plurality of transport bearer ID ranges are individually associated with one or more transport bearer parameter values of a plurality of transport bearer parameter values.

According to another aspect, an arrangement is provided, operable in a wireless communication network configured for facilitating routing of data packets in the network. The wireless communication network comprises a first network node, a second network node, and a number of routers connecting the first network node to the second network node. The arrangement comprises a processor and a memory, said memory containing instructions executable by said processor, whereby the arrangement is operative for obtaining transport bearer associations in which a plurality of transport bearer ID ranges are individually associated with one or more transport bearer parameter values of a plurality of transport bearer parameter values, and triggering provision of the obtained transport bearer associations to one or more of the number of routers.

According to another aspect, a first router is provided, operable in a wireless communication network, the first router being configured for routing data packets in the network. The wireless communication network further comprises a number of first network nodes, a number of second network nodes and a number of additional routers, the first router and the number of additional routers connecting the number of first network nodes to the number of second network nodes. The first router comprises a processor and a memory, said memory containing instructions executable by said processor, whereby the first router is operative for receiving, from the first network node, transport bearer associations in which a plurality of transport bearer ID ranges are individually associated with one or more transport bearer parameter values of a plurality of transport bearer parameter values.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a wireless communication network in which the present invention may be used.

FIGS. 2-3 are flow charts illustrating methods performed by a network node, according to possible embodiments.

FIGS. 4-5 are flow charts illustrating methods performed by a router, according to possible embodiments.

FIG. 6 is a flow chart illustrating a process performed by a network node, according to an exemplary embodiment.

FIG. 7 is a schematic block diagram illustrating a relationship between radio bearer policy and transport bearer policy.

FIG. 8 is a flow chart describing a possible algorithm for transport bearer policy generation.

FIG. 9 is a flow chart describing an exemplary bearer management process performed by a network node.

FIG. 10 is a flow chart describing an exemplary bearer management process performed by an RBS.

FIG. 11 is a schematic block diagram of an exemplary scheduling configuration according to an embodiment.

FIG. 12 is a flow chart describing a possible router packet handling process.

FIG. 13 is a flow chart describing a possible router queue allocation process.

FIG. 14 is a flow chart describing a possible router scheduling process.

FIGS. 15-16 are schematic block diagrams illustrating an arrangement in the communication network, according to possible embodiments.

FIGS. 17-18 are schematic block diagrams illustrating a router according to possible embodiments.

### DETAILED DESCRIPTION

Briefly described, a solution is provided to improve routing efficiency at routers of an IP-based wireless communication network, wherein a plurality of routers are connecting a first radio network node such as an RNC with a second radio network node such as an RBS. The solution comprises the first network node obtaining transport bearer associations, e.g. as a transport bearer table, with associations between transport bearer IDs and transport bearer parameter values, the latter defining how to treat data packets of a certain transport bearer, and thereafter sending these transport bearer associations to the routers. Then, when a data packet, to which a certain transport bearer ID is appended, is sent from the first network node towards the second network node, the router can look-up the transport bearer ID in the packet and then in the transport bearer associations, check to which transport bearer parameter the transport bearer ID is associated and treat the packet according to the associated transport bearer parameter. By such a solution it is possible for the network nodes to control treatment of the packets at the routers so that e.g. congestion at some routers is avoided.

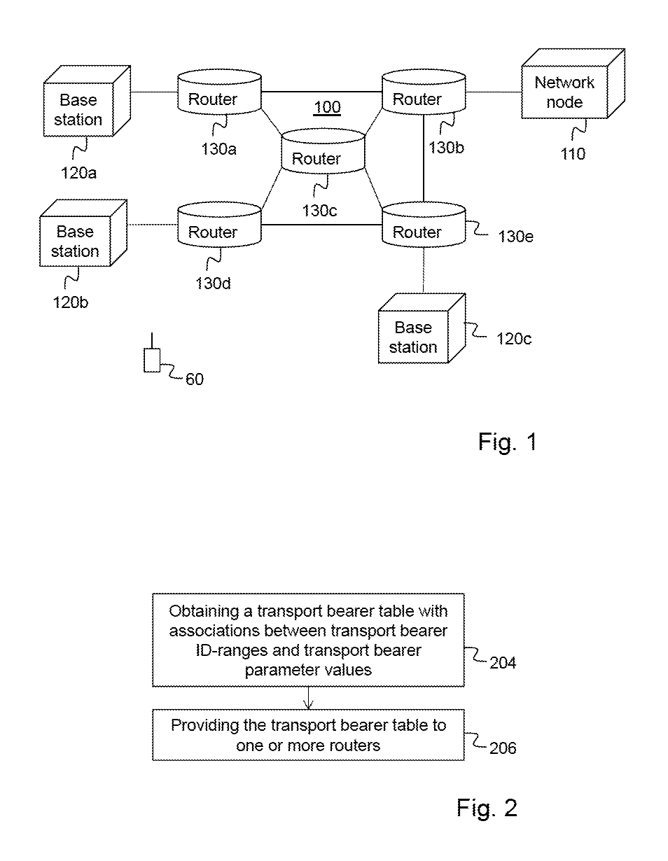

FIG. 1 shows a wireless communication network 100 in which the present invention may be used. The wireless communication network comprises a network node 110, such as an RNC, in a UTRAN context, which network node is connected to a core network (not shown) on an uplink side and to RBSs 120a-c on a downlink side. The RBSs in their turn provide wireless access to UEs 60. On a TCP/IP level, the network node 110 and the RBSs 120a-c are connected by a mesh of routers 130a-e. When IP packets are sent between the network node and the RBSs, they are routed via the routers 130a-130e. Of course there may be more than one network node in such a network 100.

FIG. 2 in conjunction with FIG. 1 shows a method performed by a wireless communication network 100 for facilitating routing of data packets in the network, the wireless communication network comprising a first network node 110; 120, a second network node 120; 110, and a number of routers 130a-e, connecting the first network node 110; 120 to the second network node. The method comprises obtaining 204 transport bearer associations in which a plurality of transport bearer ID ranges are individually associated with one or more transport bearer parameter values of a plurality of transport bearer parameter values, and triggering provision of 206 the obtained transport bearer associations to one or more of the number of routers 130a-e.

By obtaining such transport bearer associations with associations between transport bearer IDs and transport bearer parameter values and providing the associations to the routers, the first network node can control how a router is to treat incoming packets based on transport bearer parameter values. In other words, when the first network node provides such transport bearer associations to the routers, the routers get to know—by using the transport bearer ID of a received packet to look up the transport bearer parameter values valid for this transport bearer ID from the received transport bearer associations—how to process the received packet based on the associated transport bearer parameter values. This eliminates the risk of configuration conflicts of transport bearers and transport bearer parameter values between the first network node and the router. It also eliminates the need of manual programming of the router. Further, it also makes it possible to update the router with new connections between transport bearer IDs and transport bearer parameter values when any of the transport bearer associations is changed in the first network node. A transport bearer parameter value may be a weight of the data flow signifying the size/speed of the data flow, relative in relation to other data flows, or possibly a priority of the data flow to which the packet belongs. By exchange of the transport bearer associations, data flows in an IP network infrastructure can be flexibly and reliably identified and processed at transport bearer level. This is in contrast to prior art where transport bearer identifiers and parameter values must be assumed. Such assumptions may lead to misdetection and mistreatment of transport bearer flows in routers and limits the transport bearer processing flexibility in routers. By supplying transport bearer parameter values such as a weight and priority metric in the transport bearer associations, data flows can be prioritized and balanced strictly and/or relatively at transport bearer level in the network infrastructure.

A “router” is a networking device that forwards data packets between network nodes. The router may be a traditional router or a Software Defined Network, SDN, controller with attached forwarding elements. In the former control and data plane is integrated while in the latter control and data planes are separated between the SDN controller and forwarding elements. The individual transport bearer ID ranges may be associated with one or more transport bearer parameters values belonging to one or more different transport bearer parameters. One transport bearer ID range may comprise one or more transport bearer IDs, which IDs, when being more than one, may or may not be arranged in a numerical order within an ID range. The transport bearer associations may be arranged in a transport bearer table, which transport bearer table is obtained by the first network node and sent to the routers. The transport bearer associations may be sent as one collection to the routers are divided into subgroups which are sent separately. For example, the transport bearer table may be sent as one unit with all associations or divided into sub-tables that are sent separately. A “network node” may be any wireless network node handling radio applications, such as a Base Station Controller, BSC, in 2G, an RNC in 3G, a GGSN in 2G/3G, a SGSN in 2G/3G, or MME, S-GW or P-GW, in 4G. The network node may also be a radio access network node, such as a base station, e.g. a BTS in 2G, a Node B in 3G, or an evolved NodeB in 4G. Also, the invention is applicable in a non-3GPP context, for example in a Wireless Local Area Network, WLAN. The first network node may be an RNC or similar node, in which case the second network node may be a radio access network node such as a base station. Alternatively, the first network node may be a base station, in which case the second network node may be an RNC.

Transport bearer parameter values define how to process data sent over a transport bearer. For example, a transport bearer parameter may be relative weight of data flow in relation to other data flows. Another example may be a transport bearer priority value defining the importance of packets of a certain data flow to be sent over the transport bearer, i.e. delay-sensitive data such as voice has higher priority than non-delay sensitive data such as downloading of a data file. In this case the transport bearer parameter “transport bearer priority” would have a different value for delay-sensitive data than for non-delay sensitive data. Further, at least two of the transport bearer parameter values in the transport bearer associations may be mutually different. The transport bearer associations may be obtained at set up of the first network node, or they may be obtained from an external node during operation. In addition, the transport bearer associations may be set up by the first network node itself, using e.g. information such as installed bearer state. That a plurality of transport bearer ID ranges are individually associated with one or more transport bearer parameter values signifies that each of the transport bearer ID ranges has one or more transport bearer parameter values associated with it. The one or more transport bearer parameter values is selected from a plurality of different transport bearer parameter values. The ID-ranges may have mutually different associated parameter values. At least one of the ID-ranges have different parameter values than at least one of the other of the plurality of ID-ranges.

The method may be performed by the first network node or by any other network node in the wireless communication network, such as any radio access network node or any core network node. Alternatively, the method may be performed by a cloud solution wherein functionality for performing the method are spread out over different physical nodes of the network.

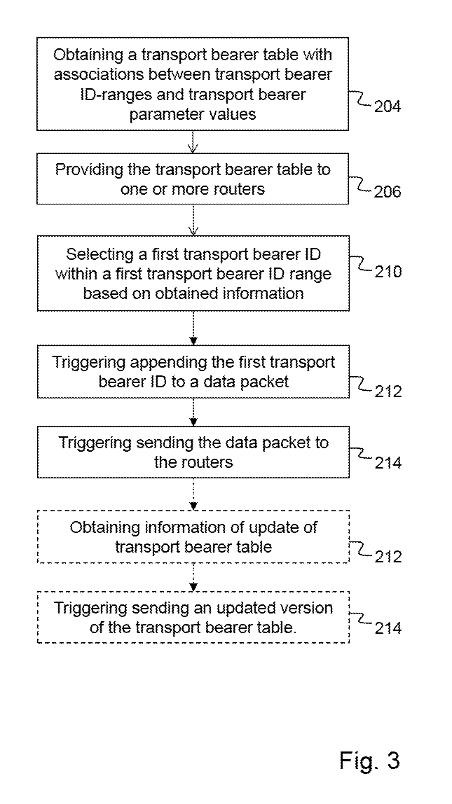

FIG. 3 shows an embodiment of the method shown in FIG. 2 where the method in addition to the features marked 204 and 206 may comprise other features. According to one embodiment, the method further comprises selecting, 210 for a radio bearer, from the transport bearer associations, a first transport bearer ID within a first transport bearer ID range of the plurality of transport bearer ID ranges, based on obtained information, and when receiving a data packet related to the radio bearer, triggering appending 212 the selected first transport bearer ID to the data packet, and triggering sending 214 the data packet with the appended first transport bearer ID to the one or more of the routers.

The obtained information may be information of a radio bearer set-up request message. The obtained information may lead the network node to select a transport bearer ID within the first transport bearer ID range. By such a measure, the transport bearers IDs are obtained based on obtained radio network information, and are not selected more or less randomly, which may happen if the network node can select transport bearer ID without instructions/information. Further, since the network node thereby achieves a system for allocating transport bearers, the data in the transport bearer associations may be compiled into ranges of transport bearer IDs having the same transport bearer parameter values so that the size of the transport bearer associations e.g. as a table is reduced. In addition, the network may also know more about the transport bearer configuration since it knows how the transport bearer IDs are allocated. Preferably, a transport bearer ID within the first transport bearer ID range is selected which transport bearer ID is not already occupied.

According to another embodiment, the transport bearer associations are obtained 204 based on current configured transport bearers. That the transport bearer associations are obtained based on current configured transport bearers is a way of automatically obtaining the transport bearer associations. Since the associations is obtained based on current configured transport bearers, the associations will also be automatically updated when the transport bearers are reconfigured. As an alternative, the transport bearer associations may be obtained manually, e.g. based on operator preference.

According to another embodiment, the obtained information, based on which the transport bearer ID is selected, is a first radio parameter value, which is associated with the first transport bearer ID range. The radio parameter may be e.g. Traffic Handling Priority, THP, Traffic class, TC, Guaranteed Bit Rate, GBR or delay. The first network node has access to associations between radio parameter values and transport bearer ID ranges. The associations between the radio parameter values and the transport bearer ID ranges may be arranged in a radio bearer table. The radio bearer table may be a part of the transport bearer table in such a way that radio parameter values are arranged in a third column of the transport bearer table where the radio parameter values are arranged to their respective transport bearer ID range in the transport bearer table.

According to another embodiment, the first radio parameter value is obtained from a received radio bearer setup request message, such as a RAB Setup Request message.

According to another embodiment, the method further comprises obtaining 216 information of an updated version of at least one of the transport bearer associations, and triggering sending 218 of the updated version of the at least one transport bearer association to the routers in response to the obtained information of the update. The update of the transport bearer associations may occur automatically, based on received information or instructions or it may be updated manually. When such an update has occurred, the network node obtains information that triggers sending of an updated version of the transport bearer associations to the routers.

According to another embodiment, the transport bearer parameter comprises a weight, which value indicates relative importance of a data flow of a transport bearer having the weight value, in relation other flows over other transport bearers having other weight values. The weight value may specify proportion of data flow size of a first data flow in relation to data flow sizes of other data flows, at situations when the flows have to be limited, such as at times of congestion. Such a parameter may give a more useful distribution of resources between transport bearers than a regular priority based parameter where a higher prioritized data flow takes precedence over a lower prioritized data flow.

According to another embodiment, the transport bearer parameter further comprises a priority, and wherein the priority may take precedence over the weight when routing packets in the router. The transport bearer routing parameter may alternatively or also comprise any or some of the following: maximum bitrate, maximum burst size, drop probability, drop threshold, buffer size, and maximum delay.

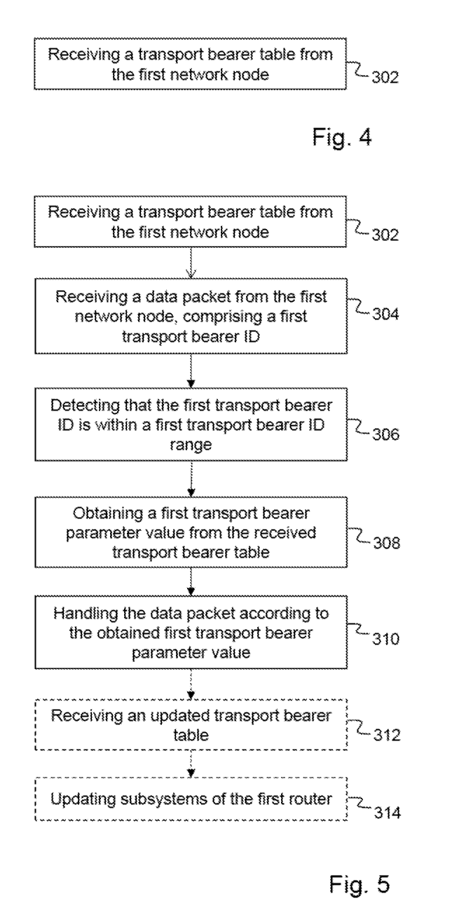

FIG. 4 in conjunction with FIG. 1 shows a method performed by a first router 130a of a wireless communication network 100 for routing data packets in the network, the wireless communication network further comprising a number of first network nodes 110; 120, a number of second network nodes 120; 110, and a number of additional routers 130b-f. The first router and the number of additional routers connect the number of first network nodes to the number of second network nodes. The method comprises receiving 302, from the first network node, transport bearer associations in which a plurality of transport bearer ID ranges are individually associated with one or more transport bearer parameter values of a plurality of transport bearer parameter values.

When the first router receives an actual data packet, the router can, by detecting the transport bearer ID of the received packet, e.g. from the header of the packet, and by checking the received transport bearer associations, know what transport bearer parameter value this transport bearer is allocated by the network node, and make a processing decisions based on this. The router may also reconfigure itself, for example its packet queueing system, to perform in accordance with the data expressed in the transport bearer associations.

According to another embodiment, a first transport bearer ID range of the transport bearer associations is associated with a first transport bearer parameter value, Further, the method comprises receiving 304 a data packet from the first network node, the data packet comprising a first transport bearer ID, detecting 306 that the first transport bearer ID is within the first transport bearer ID range, obtaining 308 the first transport bearer parameter value from the received transport bearer associations, and handling 310 the received data packet according to the obtained first transport bearer parameter value. Such a method describes how a router can handle the data packet according to a transport bearer parameter value controlled by the radio network. Thereby, the radio network can control how the routers treat the packet, for example based on priority or weight of the data flow to which the packet belongs. The first transport bearer ID may be situated in the header of the data packet.

According to another embodiment, the method performed by the router further comprises receiving 312, from the first network node, an updated version of at least one of the transport bearer associations, and updating 314 subsystems of the first router based on the received updated version. The subsystems may be e.g. a load balancing subsystem and/or a scheduling subsystem. The data of the updated version may then be used in the subsystems for later received data packets

According to another embodiment, the transport bearer parameter comprises a weight, which value indicates relative importance of a data flow of a transport bearer having the weight value in relation other flows over other transport bearers having other weight values.

In the following some detailed exemplary embodiments of the invention are described. According to one embodiment, the invention comprises a mobile network control process, a bearer management process, and a router packet process. The mobile network control process generates a transport bearer policy from a radio bearer policy and communicates the transport bearer policy between network nodes and routers. The transport bearer policy may signify the transport bearer associations, e.g. the transport bearer table. The radio bearer policy may signify the association between radio bearer parameter values and transport bearer IDs, e.g. the radio bearer table. The bearer management process organizes transport bearers according to the installed transport bearer policy. The router packet process classifies data flows and data packets of the data flows to transport bearers, uses the associated installed transport bearer policy to select one out of several possible output ports and to schedule packets on output ports, and dynamically allocates output port queues to transport bearer flows.

The example embodiment of the general invention is given only in an UTRAN (3G access) context. However, the general invention applies also to applications in other PLMN domains like E-UTRAN (4G access), GERAN (2G access), EPC (4G core), GPRS core (2G/3G core), Wi-Fi access (non-3GPP access), and fixed access (non-3GPP access).

Example embodiment of the mobile network control process. This example embodiment presumes that a radio bearer policy has been installed in the RNC by e.g. an Operation and Support System, or a network management system, OSS/NMS. A radio bearer policy in this context maps a set of radio bearer attributes to a priority value and a weight. The radio bearer attributes may also be called radio parameter values. Example UTRAN radio bearer attributes are Traffic Class, Signaling Indicator, and Traffic Handling Priority. In the user plane, each radio bearer established in UTRAN is assigned priority and weight according to the configured radio bearer policy. The radio bearer attributes that are used to map to a radio bearer policy are provided in the RAB setup request message from the core network. The example embodiment further requires that the RNC knows what priority values to work with and what Node Bs and routers to interact with. If not possible to discover automatically, this needs to be configured in the RNC for this control process to work.

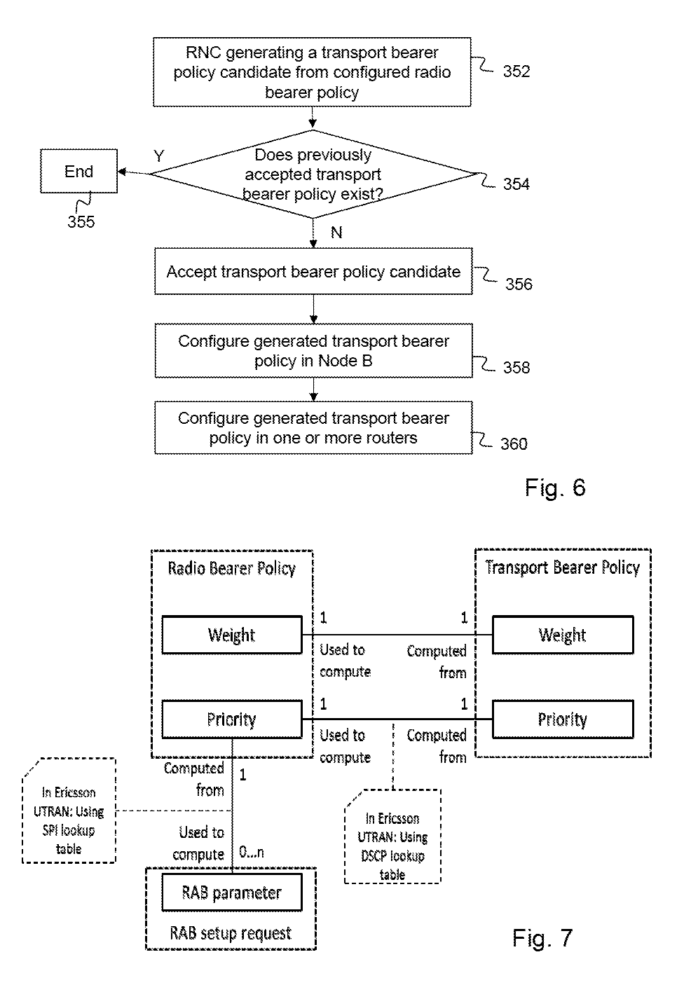

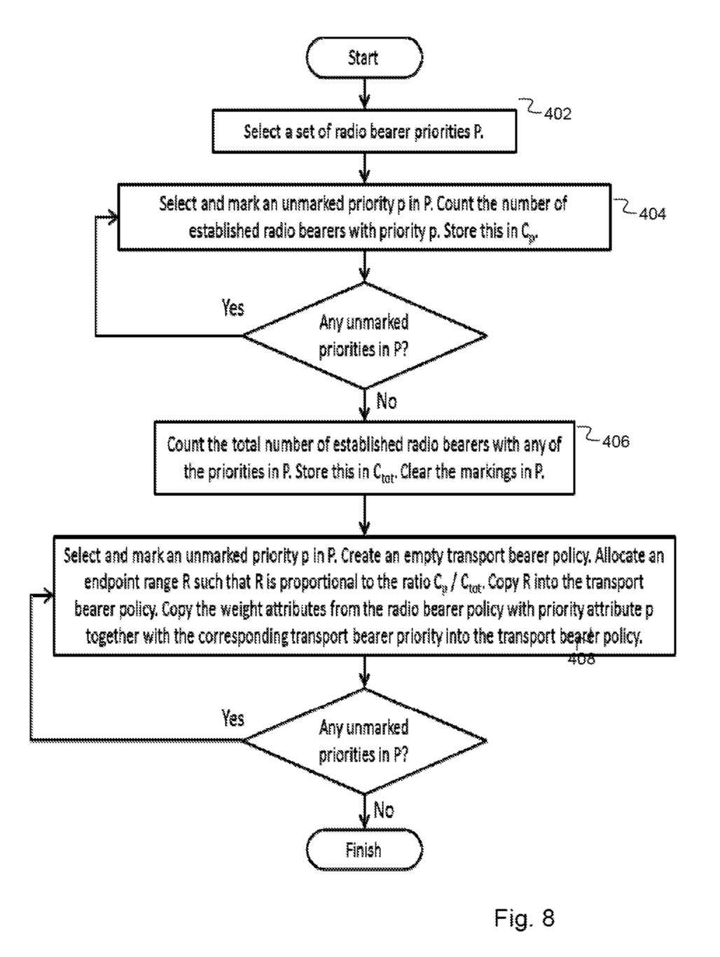

With this in mind, the following steps explain the full control process in an UTRAN context, see FIG. 1 and FIG. 6: The RNC 110 generates 352 a transport bearer policy candidate from configured radio bearer policy. Transport bearer policy and radio bearer policy are thus interrelated. FIG. 6 shows this interrelation in Unified Modeling Language, UML, notation.

The transport bearer policy describes the treatment of transport bearers that the RNC wants the routers to do. More specifically, the transport bearer policy expresses a transport bearer ID range, and a set of transport bearer attributes related to the transport bearers in the expressed transport bearer range. The transport bearer attributes may also be called transport bearer parameter values. The transport bearer ID range may be expressed by two endpoint ranges: an Uplink Endpoint Range and a Downlink Endpoint Range. Each endpoint range specifies a range of transport bearer endpoint identifiers.

In UTRAN, transport bearer endpoints are identified by IP address and UDP port. In this case, the transport bearer ID range expresses ranges of the following endpoints: Downlink endpoint, e.g. Node B IP address and/or Node B UDP port, and Uplink endpoint, e.g. RNC IP address and/or RNC UDP port. Ultimately, these ranges express a unique set of UTRAN transport bearers. For each transport bearer ID range, a set of transport bearer attributes are specified. These attributes may be separated into uplink and downlink attributes to enable differentiation between the uplink and downlink. In terms of actual attributes, the only attribute identified in this example embodiment is an uplink and a downlink weight.

Transport bearer policy may be generated by different algorithms. The initial algorithm employed by this example embodiment is the following, see also FIG. 7: For each pair of RNC and Node B in the RNS, select 402 a number of radio bearer priorities P. For each priority p in P, count 404 the number of established radio bearers and store this in C_{p.} Count 406 the total number of established radio bearers with any of the priorities in P. Store this in Cₜₒₜ. For each priority p in P, create 408 an empty transport bearer policy, allocate an endpoint range R such that R is proportional to the ratio Cₚ/Cₜₒₜ, copy R into the transport bearer policy, copy the weight attributes from the radio bearer policy with priority attribute p into the transport bearer policy, and copy the transport bearer priority related to radio bearer priority p into the transport bearer policy.

After this algorithm is completed, the RNC will have generated (352 of FIG. 6) N_{RNC-Node B pairs}*N_{selected radio bearer priorities} transport bearer policies. What radio bearer priorities are selected may be configured in the RNC or derived via the radio bearer Traffic Class QoS attribute.

Going back to FIG. 6, after having generated transport bearer policy candidates, the RNC checks 354 if previously accepted transport bearer policy exists. If it does and the computed change in policy is insignificant, then the transport bearer policy candidate is discarded and the control process iteration aborted 355. If no transport bearer policy exists or if the transport bearer policy candidate is significantly different from the existing transport bearer policy, then the RNC accepts 356 the transport bearer policy candidate as the new transport bearer policy and continues with configuring 358 the generated transport bearer policy relevant to each Node B in the Node Bs. In case this is not done, the RNC instead signals the required downlink UDP port range during bearer establishment. This is covered as an optional step in the updated bearer management process. Then the RNC configures 360 the generated transport bearer policy in one or more routers.

During operation, the OSS/NMS may reconfigure the RNC radio bearer policy and/or the RNC radio bearer resource state may change, possibly by a required magnitude. In case this occurs, the RNC starts another iteration of the control process. It is also possible that Node Bs or routers restart outside the control of the RNC. When the RNC detects this, the RNC re-downloads the relevant transport bearer policies to the affected units. This keeps the network configuration in a consistent state. This may require liveness detection to be implemented between Node B/routers and the RNC.

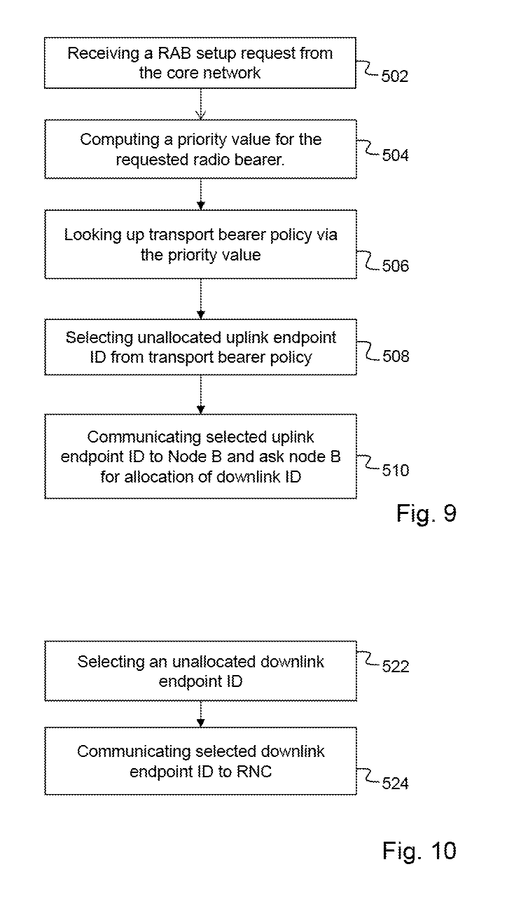

Example embodiment of bearer management process in radio nodes. FIG. 9 shows the part of the bearer management process performed in the RNC. The process starts by the RNC receiving 502 a RAB setup request from the core network. The RNC then computes 504 a priority value for the requested radio bearer. Thereafter, the RNC looks up 506 the transport bearer policy via the priority value, where after the RNC selects 508 an unallocated uplink endpoint identifier from the Uplink Endpoint Range described in the transport bearer policy. The RNC then communicates 510 the selected uplink endpoint identifier to the required Node B and asks the NodeB for an allocation of downlink endpoint identifier via e.g. NBAP. The RNC optionally includes the related Downlink Endpoint Range. Thereafter, in FIG. 10, the part of the bearer management process performed in the Node B is described. In response to step 510, the Node B selects 522 an unallocated downlink endpoint identifier from the Downlink Endpoint Range either supplied out-of-band, via the control process, or in the NBAP signaling message. The Node B then communicates 524 the selected endpoint identifier to the RNC. The radio bearer is then established on both ends, i.e. at the RNC and at the Node B, with the selected transport bearer endpoint identifiers. The difference between the described and an existing bearer management process lies in that transport bearer endpoint identifier selection is organized supported by installed transport bearer policy.

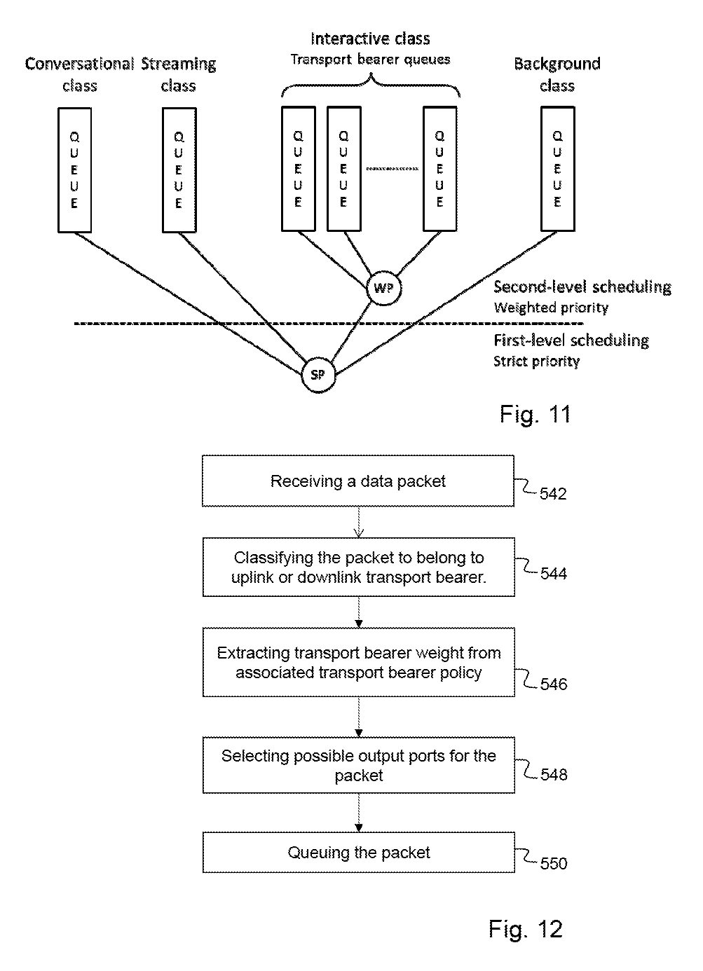

Example embodiment of updated router packet process. To be able to do normal transport flow prioritization in combination with transport bearer weighted prioritization, the router needs to support hierarchical scheduling. At the first scheduling level, the scheduler schedules based on transport priorities. Then, for some of the priorities, a second scheduling level based on bearer transport weights is employed. To achieve weighted fairness between transport bearers, the scheduling discipline employed at the second scheduling level should be weighted fair. An example of such discipline is Weighted Fair Queuing. FIG. 11 shows an example scheduling configuration that meets the discussed requirements. As understood from FIG. 11, in a first scheduling level a strict priority is performed so that data in a higher class is prioritized before data in another class. This is advantageously performed so that all or at least most data in a higher prioritized class is sent before data in a lower prioritized class is sent, up to a certain delay at least. In FIG. 11 four different classes are shown: Conversational class, which is very delay-sensitive and has the highest priority, followed by, in sinking priority order, Streaming class, Interactive class, and Background class. FIG. 11 also describes that for data streams in the same class, a second level scheduling may take place, in which the queues may be weighted differently.

Because the number of available router queues is vastly less than the number of expressible flows, the router packet process needs to support dynamic queuing. This requires updates to the router forwarding and scheduling processes. FIG. 12 shows an exemplary router packet/forwarding process with classification to transport bearer flow, weighted load balancing, and dynamic queue allocation in a weighted scheduler configuration. The process starts by the router receiving an IP packet. The router then classifies 544 the packet to belong to an uplink or downlink transport bearer by matching the installed transport bearer ranges with the IP packet headers. The router then extracts 546 uplink or downlink transport bearer weight from the associated transport bearer policy. The router selects 548 the set of possible output ports for the packet, a.k.a. routing. If load balancing is enabled, and routing discovered multiple possible output ports, then the router includes the transport bearer weight in the output port selection, for example by extending the hash key when using a hash function. Once the output port has been selected, the router dynamically queues 550 the packet in the following manner.

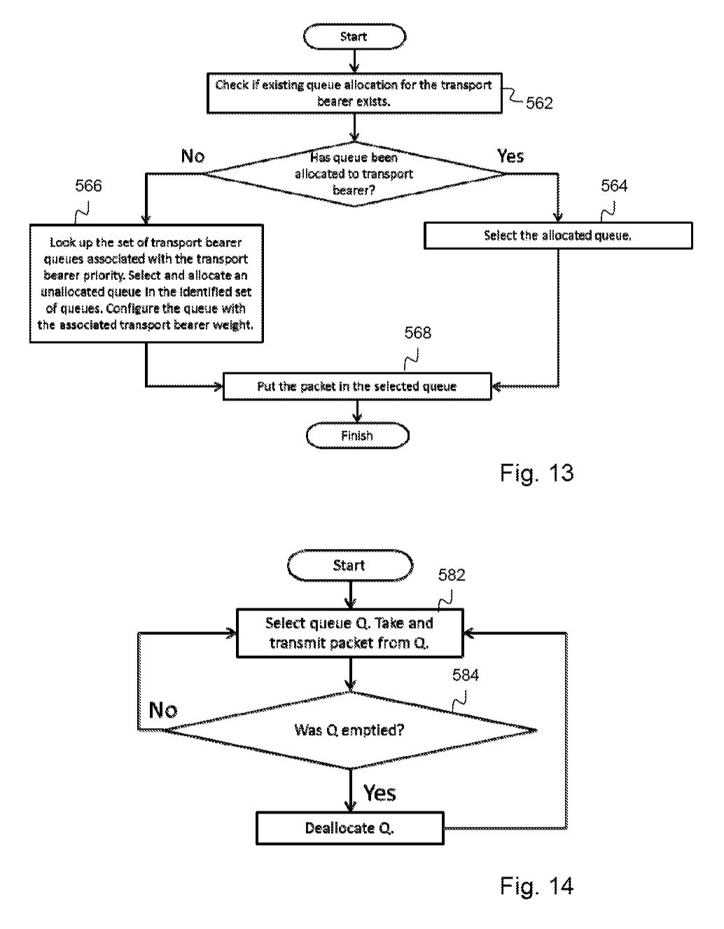

The queuing may be performed as suggested in a method described in FIG. 13. This method starts by the router checking 562 whether the transport bearer is already allocated a queue on the output port. If a queue has already been allocated, then this queue is selected 564. If a queue has not yet been allocated, then the router looks 566 up the set of transport bearer queues associated with the transport bearer priority, selects an unallocated queue in the identified set of queues, allocates the selected queue to the related transport bearer and configures the selected queue with the associated transport bearer weight. Thereafter, the packet is put 568 in the selected queue.

Packets put into the router queues are continuously removed by the router schedulers. One bottom-level scheduler is typically used per output port. If hierarchical scheduling is supported, then another scheduler level can be added on top of the other. This example embodiment requires at least two hierarchical scheduling levels and that the second level supports weighted priority scheduling. FIG. 14 explains the updated router scheduling process on an output port. The scheduling process starts by selecting 582 queue Q, taking and transmitting packet from Q. If queue Q was emptied 584, then deallocating 586 Q, in other words select another Q. Then repeat from Step 582.

Differences between the updated router processes and normal router processes are the classification to transport bearer based on installed state, weighted load balancing and scheduling based on the associated transport bearer weight, and the dynamic queue allocation.

Embodiments of the present invention have one or more of the following advantages: Mobile operators can quickly and efficiently configure weighted (gold, silver, bronze) subscriber fairness in the IP network infrastructure and configure weighted transport bearer flow load balancing in the IP network infrastructure. Further, compared with today's ECMP load-balancing processes, transport bearer flows are less randomly mapped onto IP network infrastructure paths. By introducing a flow weight into the path selection process, flows can be balanced by size instead of by name. Compared with radio node flow control solutions, there is no flow control bias introduced by scheduling. This results in more precise fairness control, especially in a multi-standard environment. Compared with standard router management, the time to market for mobile network services is reduced and the risk for misconfigurations is reduced. The solution also enables dynamic adaptation to changing radio node flow characteristics on smaller time scales. Automatic router reconfiguration could be supported with operational efficiency on a daily basis or even more frequently. Compared with standard router operation, the assistance of the radio application lessens processing load put on the router to enable the desired load balancing and scheduling functions.

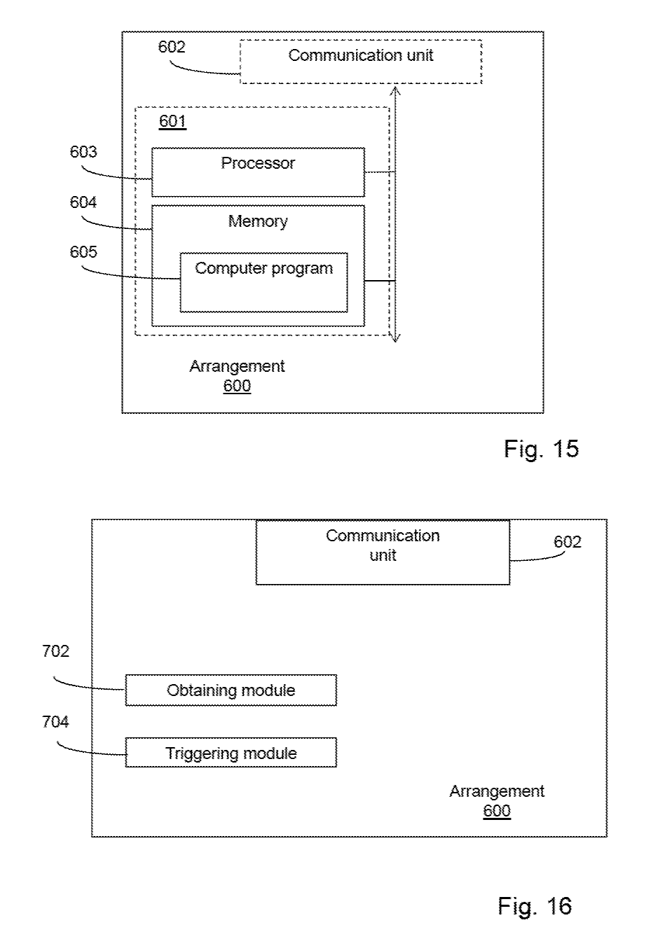

FIG. 15, in conjunction with FIG. 1, describes an arrangement 600 operable in a wireless communication network 100 configured for facilitating routing of data packets in the network. The wireless communication network comprises a first network node 110; 120, a second network node 120; 110 and a number of routers 130a-e connecting the first network node 110; 120 to the second network node. The arrangement 600 comprises a processor 603 and a memory 604, said memory containing instructions executable by said processor, whereby the arrangement 600 is operative for obtaining transport bearer associations in which a plurality of transport bearer ID ranges are individually associated with one or more transport bearer parameter values of a plurality of transport bearer parameter values, and triggering provision of the obtained transport bearer associations to one or more of the number of routers 130a-e. The arrangement 600 may be located in the first network node 110; 120 or in any other network node, such as in a gateway or in a core network node. Alternatively, the arrangement may be spread out over many different nodes in the network, in a so called cloud solution.

According to an embodiment, the arrangement is further operative for selecting, for a radio bearer, from the transport bearer associations, a first transport bearer ID within a first transport bearer ID range of the plurality of transport bearer ID ranges, based on obtained information, triggering appending, when receiving a data packet related to the radio bearer, the selected first transport bearer ID to the data packet. And triggering sending the data packet with the appended first transport bearer ID to the one or more of the routers.

According to another embodiment, the arrangement is operative for obtaining the transport bearer associations based on current configured transport bearers.

According to another embodiment, the obtained information, based on which the transport bearer ID is selected, is a first radio parameter value, which is associated with the first transport bearer ID range.

According to another embodiment, the arrangement is operative to obtain the first radio parameter value from a received radio bearer setup request message.

According to another embodiment, the arrangement is further operative for obtaining information of an updated version of at least one of the transport bearer associations, and triggering sending of the updated version of the at least one transport bearer association to the one or more of the routers in response to the obtained information of the update.

The arrangement 600 may further comprise a communication unit 602, which may be considered to comprise conventional means for communicating from and/or to other nodes in the communication network. The communication unit 602 may comprise one or more communication ports for communicating with the other nodes in the network and/or a wireless transceiver in case the arrangement is arranged in a radio access node, i.e. a BTS. The instructions executable by said processor may be arranged as a computer program 605 stored in said memory 604. The processor 603 and the memory 604 may be arranged in a sub-arrangement 601. The sub-arrangement 601 may be a micro processor and adequate software and storage therefore, a Programmable Logic Device, PLD, or other electronic component(s)/processing circuit(s) configured to perform the actions, or methods mentioned above.

FIG. 16 in conjunction with FIG. 1 describes another embodiment of an arrangement 600, similar to the arrangement of FIG. 15, the arrangement being operable in a wireless communication network 100 configured for facilitating routing of data packets in the network. The wireless communication network comprises a first network node 110; 120, a second network node 120; 110 and a number of routers 130a-e connecting the first network node 110; 120 to the second network node. The arrangement comprises an obtaining module 702 for obtaining transport bearer associations in which a plurality of transport bearer ID ranges are individually associated with one or more transport bearer parameter values of a plurality of transport bearer parameter values, and a triggering module 704 for triggering provision of the obtained transport bearer associations to one or more of the number of routers 130a-e.

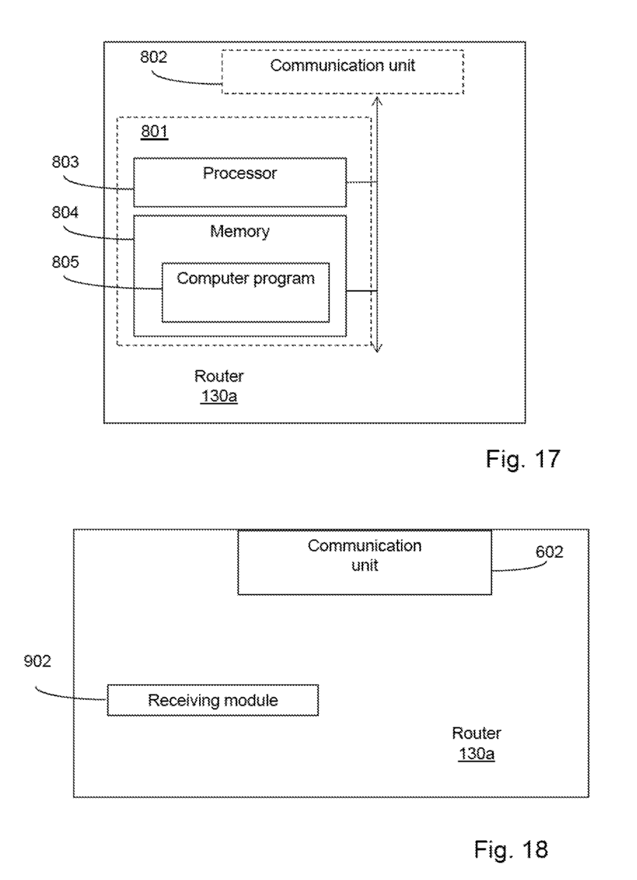

FIG. 17 in conjunction with FIG. 1 describes an embodiment of a first router 130a operable in a wireless communication network 100, configured for routing data packets in the network. The wireless communication network further comprises a number of first network nodes 110; 120, a number of second network nodes 120; 110 and a number of additional routers 130b-f. The first router and the number of additional routers connecting the number of first network nodes to the number of second network nodes. The first router 130a comprises a processor 803 and a memory 804, said memory containing instructions executable by said processor, whereby the first router 130a is operative for receiving, from the first network node, transport bearer associations in which a plurality of transport bearer ID ranges are individually associated with one or more transport bearer parameter values of a plurality of transport bearer parameter values.

According to an embodiment, a first transport bearer ID range in the transport bearer associations is associated with a first transport bearer parameter value. Further, the first router is operative for receiving a data packet from the first network node, the data packet comprising a first transport bearer ID and for detecting that the first transport bearer ID is within the first transport bearer ID range. Further, the first router is operative for obtaining the first transport bearer parameter value from the received transport bearer associations, and for handling the received data packet according to the obtained first transport bearer parameter value.

According to another embodiment, the first router is further operative for receiving, from the first network node, an updated version of at least one of the transport bearer associations, and updating subsystems of the first router based on the received updated version.

According to another embodiment, the transport bearer parameter comprises a weight, which value indicates relative importance of a data flow of a transport bearer having the weight value in relation other flows over other transport bearers having other weight values.

The first router 130a may further comprise a communication unit 802, which may be considered to comprise conventional means for communicating from and/or to other nodes in the communication network, such as other routers and first and second network nodes. The communication unit 802 may comprise one or more communication ports for communicating with the other nodes in the network. The instructions executable by said processor may be arranged as a computer program 805 stored in said memory 804. The processor 803 and the memory 804 may be arranged in a sub-arrangement 801. The sub-arrangement 801 may be a micro processor and adequate software and storage therefore, a Programmable Logic Device, PLD, or other electronic component(s)/processing circuit(s) configured to perform the actions, or methods mentioned above.

FIG. 18 in conjunction with FIG. 1 describes another embodiment of the first router 130a, which has some smilarities to the first router of FIG. 17, the arrangement being operable in a wireless communication network 100, configured for routing data packets in the network. The wireless communication network further comprises a number of first network nodes 110; 120, a number of second network nodes 120; 110, and a number of additional routers 130b-f. The first router and the number of additional routers connect the number of first network nodes to the number of second network nodes. The first router 130a comprises a receiving module 902 for receiving, from the first network node, transport bearer associations in which a plurality of transport bearer ID ranges are individually associated with one or more transport bearer parameter values of a plurality of transport bearer parameter values.

The computer programs 605 and 805, in FIGS. 15 and 17, respectively, may comprise computer readable code means, which when run in the arrangement/the router causes the arrangement/the router to perform the steps described in any of the described embodiments. The computer program 605; 805 may be carried by a computer program product connectable to the processor 603; 803. The computer program product may be the memory 604; 804. The memory 604; 804 may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory 604; 804. Alternatively, the computer program may be stored on a server or any other entity connected to the communication network to which the arrangement/the router has access via its communication unit 602; 802. The computer program may then be downloaded from the server into the memory 604; 804.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby.

| Abbreviation | Explanation |
|---|---|
| 2G | Second generation. |
| 3G | Third generation. |
| 4G | Fourth generation. |
| 3GPP | Third-generation Partnership Program |
| BTS | Base Transceiver Station (2G network node) |
| BSC | Base Station Controller (2G network node) |
| GTP | GPRS Tunneling Protocol |
| IP | Internet Protocol |
| UDP | User Datagram Protocol |
| TCP | Transmission Control Protocol |
| MME | Mobility Management Entity (4G network node) |
| RNC | Radio Network Controller (3G network node) |
| NB | Node B (3G network node) |
| eNB | Evolved Node B (4G network node) |
| RBS | Radio Base Station (general name for base station node) |
| PDN | Packet Data Network |
| DSCP | Differentiated Services Code Point |
| ECMP | Equal-Cost Multi-Path |
| AQM | Active Queue Management |
| ConEx | Congestion Exposure |
| UMTS | Universal Mobile Telephony System (3G mobile network) |
| EPS | Evolved Packet System (4G mobile network) |
| EPC | Evolved Packet Core (4G packet core network) |
| GPRS | General Packet Radio Service (2G/3G packet service) |
| S-GW | Serving GateWay (4G network node) |
| P-GW | PDN GateWay (4G network node) |
| SGSN | Serving GPRS Support Node (2G/3G network node) |
| GGSN | Gateway GPRS Support Node (2G/3G network node) |
| PLMN | Public Land Mobile Network |
| TEID | Tunnel End-point Identifier |
| QCI | QoS Class Identifier |
| QoS | Quality of Service |
| UTRAN | Universal Terrestrial Radio Access Network (3G RAN) |
| GERAN | GSM EDGE Radio Access Network (2G RAN) |
| E-UTRAN | Evolved UTRAN (4G RAN) |
| GSM | Global System for Mobile Communications (2G mobile |
| | network) |
| Wi-Fi | Wireless Fidelity (commercial name for IEEE 802.11 |
| | Wireless LAN access) |
| RNS | Radio Network Subsystem (subset of UTRAN) |

1. A method performed by a wireless communication network for facilitating routing of data packets in the network, the wireless communication network comprising a first network node, a second network node and a number of routers connecting the first network node to the second network node, the method comprising:
obtaining transport bearer associations in which a plurality of transport bearer ID ranges are individually associated with one or more transport bearer parameter values of a plurality of transport bearer parameter values; and
triggering provision of the obtained transport bearer associations to one or more of the number of routers.

2. The method according to claim 1, further comprising:
selecting, for a radio bearer, from the transport bearer associations, a first transport bearer ID within a first transport bearer ID range of the plurality of transport bearer ID ranges, based on obtained information;
triggering appending, when receiving a data packet related to the radio bearer, the selected first transport bearer ID to the data packet; and
triggering sending the data packet with the appended first transport bearer ID to the one or more of the routers.

3. The method according to claim 1, wherein the transport bearer associations are obtained based on current configured transport bearers.

4. The method according to claim 2, wherein the obtained information, based on which the transport bearer ID is selected, is a first radio parameter value, which is associated with the first transport bearer ID range.

5. The method according to claim 4, wherein the first radio parameter value is obtained from a received radio bearer setup request message.

6. The method according to claim 1, further comprising:
obtaining information of an updated version of at least one of the transport bearer associations; and
triggering sending of the updated version of the at least one transport bearer association to the one or more of the routers in response to the obtained information of the update.

7. The method according to claim 1, wherein the transport bearer parameter comprises a weight, which value indicates relative importance of a data flow of a transport bearer having the weight value in relation other flows over other transport bearers having other weight values.

8. The method according to claim 7, wherein the transport bearer parameter further comprises a priority, and wherein the priority may take precedence over the weight when routing packets in the router.

9. A method performed by a first router of a wireless communication network for routing data packets in the network, the wireless communication network further comprising a number of first network nodes, a number of second network nodes and a number of additional routers, the first router and the number of additional routers connecting the number of first network nodes to the number of second network nodes, the method comprising:
receiving, from at least one of the first network nodes, transport bearer associations in which a plurality of transport bearer ID ranges are individually associated with one or more transport bearer parameter values of a plurality of transport bearer parameter values.

10. The method according to claim 9, wherein a first transport bearer ID range in the transport bearer associations is associated with a first transport bearer parameter value, the method further comprising:
receiving a data packet from the first network node, the data packet comprising a first transport bearer ID;
detecting that the first transport bearer ID is within the first transport bearer ID range;
obtaining the first transport bearer parameter value from the received transport bearer associations; and
handling the received data packet according to the obtained first transport bearer parameter value.

11. The method according to claim 9, further comprising:
receiving from the first network node, an updated version of at least one of the transport bearer associations; and
updating subsystems of the first router based on the received updated version.

12. The method according to claim 9, wherein the transport bearer parameter comprises a weight, which value indicates relative importance of a data flow of a transport bearer having the weight value in relation other flows over other transport bearers having other weight values.

13. An arrangement operable in a wireless communication network configured for facilitating routing of data packets in the network, the wireless communication network comprising a first network node, a second network node and a number of routers connecting the first network node to the second network node, the arrangement comprising:
a processor; and
a memory, said memory containing instructions executable by said processor, whereby the arrangement is operative for:
obtaining transport bearer associations in which a plurality of transport bearer ID ranges are individually associated with one or more transport bearer parameter values of a plurality of transport bearer parameter values; and
triggering provision of the obtained transport bearer associations to one or more of the number of routers.

14. The arrangement according to claim 13, further being operative for:
selecting, for a radio bearer, from the transport bearer associations, a first transport bearer ID within a first transport bearer ID range of the plurality of transport bearer ID ranges, based on obtained information;
triggering appending, when receiving a data packet related to the radio bearer, the selected first transport bearer ID to the data packet; and
triggering sending the data packet with the appended first transport bearer ID to the one or more of the routers.

15. The arrangement according to claim 13, wherein the arrangement is operative for obtaining the transport bearer associations based on current configured transport bearers.

16. The arrangement according to claim 14, wherein the obtained information, based on which the transport bearer ID is selected, is a first radio parameter value, which is associated with the first transport bearer ID range.

17. The arrangement according to claim 16, further being operative to obtain the first radio parameter value from a received radio bearer setup request message.

18. The arrangement according to claim 13, further being operative for:
obtaining information of an updated version of at least one of the transport bearer associations; and
triggering sending of the updated version of the at least one transport bearer association to the one or more of the routers in response to the obtained information of the update.

19. An arrangement operable in a wireless communication network configured for facilitating routing of data packets in the network, the wireless communication network comprising a first network node, a second network node and a number of routers connecting the first network node to the second network node, the arrangement comprising:
an obtaining module for obtaining transport bearer associations in which a plurality of transport bearer ID ranges are individually associated with one or more transport bearer parameter values of a plurality of transport bearer parameter values; and
a triggering module for triggering provision of the obtained transport bearer associations to one or more of the number of routers.

20. A first router operable in a wireless communication network, configured for routing data packets in the network, the wireless communication network further comprising a number of first network nodes, a number of second network nodes and a number of additional routers, the first router and the number of additional routers connecting the number of first network nodes to the number of second network nodes, the first router comprising:
a processor; and
a memory, said memory containing instructions executable by said processor, whereby the first router is operative for:
receiving, from the first network node, transport bearer associations in which a plurality of transport bearer ID ranges are individually associated with one or more transport bearer parameter values of a plurality of transport bearer parameter values.

21. The first router according to claim 20, wherein a first transport bearer ID range in the transport bearer associations is associated with a first transport bearer parameter value, the first router further being operative for:
receiving a data packet from the first network node, the data packet comprising a first transport bearer ID;
detecting that the first transport bearer ID is within the first transport bearer ID range;
obtaining the first transport bearer parameter value from the received transport bearer associations; and
handling the received data packet according to the obtained first transport bearer parameter value.

22. The first router according to claim 20, further being operative for:
receiving, from the first network node, an updated version of at least one of the transport bearer associations; and
updating subsystems of the first router based on the received updated version.

23. The first router according to claim 20, wherein the transport bearer parameter comprises a weight, which value indicates relative importance of a data flow of a transport bearer having the weight value in relation other flows over other transport bearers having other weight values.

24. A first router operable in a wireless communication network, configured for routing data packets in the network, the wireless communication network further comprising a number of first network nodes, a number of second network nodes and a number of additional routers, the first router and the number of additional routers connecting the number of first network nodes to the number of second network nodes, the first router comprising:
a receiving module for receiving, from at least one of the first network nodes, transport bearer associations in which a plurality of transport bearer ID ranges are individually associated with one or more transport bearer parameter values of a plurality of transport bearer parameter values.

25. A computer readable medium configured to be run in an arrangement of a wireless communication network, configured for facilitating routing of data packets in the network, the wireless communication network comprising a first network node, a second network node and a number of routers connecting the first network node to the second network node, which computer readable medium when run in the arrangement causes the arrangement to perform the following steps:
obtaining transport bearer associations in which a plurality of transport bearer ID ranges are individually associated with one or more transport bearer parameter values of a plurality of transport bearer parameter values; and
triggering provision of the obtained transport bearer associations to one or more of the number of routers.

26. (canceled)

27. A computer readable medium to be run in a first router operable in a wireless communication network, configured for routing data packets in the network, the wireless communication network further comprising a number of first network nodes, a number of second network nodes and a number of additional routers, the first router and the number of additional routers connecting the number of first network nodes to the number of second network nodes, which computer readable medium when run in the first router, causes the first router to:
receive, from at least one of the first network nodes, transport bearer associations in which a plurality of transport bearer ID ranges are individually associated with one or more transport bearer parameter values of a plurality of transport bearer parameter values.

28. (canceled)
